(19) United States
(12) Patent Application Publication
(10) Pub. No.: US 2012/0327987 A1
(43) Pub. Date: Dec. 27, 2012

(54) EXTENDED DURATION PHY HEADER FOR PLC

(75) Inventors: ANAND G. DABAK, PLANO, TX (US); TARKESH PANDE, DALLAS, TX (US); IL HAN KIM, DALLAS, TX (US)

(73) Assignee: TEXAS INSTRUMENTS INCORPORATED, Dallas, TX (US)

(21) Appl. No.: 13/529,107

(22) Filed: Jun. 21, 2012

Related U.S. Application Data
(60) Provisional application No. 61/499,379, filed on Jun. 21, 2011.

(51) Int. Cl. H04B 3/54; H04B 1/38

(52) U.S. Cl. 375/222; 375/257

(57) ABSTRACT

A method of powerline communications (PLC) over a PLC channel including a first node and at least a second node utilizes an algorithm that compiles frames having extended duration physical layer (PHY) headers. A duration or estimated duration of a null of the PLC channel is provided. An extended duration PHY header is compiled including a plurality of symbols and bits having a time duration of the PHY header of at least fifty percent (50%) more than the duration or estimated duration of the null. The compiling includes symbol repetition of at least a portion of the plurality of symbols or bit repetition of at least a portion of the plurality of bits. The first node transmits a frame including a preamble and the extended duration PHY header over the PLC channel to at least the second node.

### CROSS REFERENCE TO RELATED APPLICATIONS

This application and the subject matter disclosed herein claims the benefit of Provisional Application Ser. No. 61/499,379 entitled “Frame Control Header Repetition Rate” filed Jun. 21, 2011, which is herein incorporated by reference in its entirety.

### FIELD

Disclosed embodiments relate generally to the field of powerline communications, and more specifically to physical layer (PHY) headers of frames.

### BACKGROUND

Powerline communications (PLC) include systems for communicating data over the same medium (i.e., a wire or conductor) that is also used to transmit electric power to residences, buildings, and other premises. Once deployed, PLC systems may enable a wide array of applications, including, for example, automatic meter reading and load control (i.e., utility-type applications), automotive uses (e.g., charging electric cars), home automation (e.g., controlling appliances, lights, etc.), and/or computer networking (e.g., Internet access), to name only a few.

Current and next generation narrow band PLC are multi-carrier based, such as orthogonal frequency division multiplexing (OFDM)-based (as opposed to frequency shift keying (FSK)-based) in order to get higher network throughput. OFDM uses multiple orthogonal subcarriers to transmit data over frequency selective channels. A conventional OFDM structure for a data frame includes a preamble, followed by a physical layer (PHY) header, a media access control (MAC) header, and a MAC (data) payload.

The PHY header includes information regarding the physical frame format used to allow the receiver to get synchronized to the transmitter. Accordingly, recovering physical header information at a receiving node is important in communication systems because failure to properly receive certain PHY header information can result in the entire frame not being recoverable even though the rest of frame is uncorrupted.

One OFDM-based PLC standard is IEEE P1901.2. IEEE P1901.2 version 3.4 (hereafter herein “IEEE P1901.2”) is designed to secure PLC at data rates up to 500 kbps, at transmission frequencies between 150 and 480 kHz, Federal Communications Commission (FCC) band. In IEEE P1901.2 the PHY header is referred to as a frame control header (FCH). The IEEE P1901.2 system estimates the signal-to-noise ratio (SNR) of the received signal subcarriers and adaptively selects from the usable 11 tones, modulation, and code rate to provide communication over the PLC channel.

FIGS. 1A-C show the IEEE P1901.2 standard-based structure of a data frame 100 for a PHY where the PHY header is shown as a FCH 120, the fields in the FCH 120, and the signal processing block structure 160 for transmitting frames including the FCH 120 (transceiver not shown), respectively. As shown in FIG. 1A, data frame 100 includes a preamble 110, a FCH 120, a MAC header 130, a MAC (data) payload 140, and a FCS 150. The preamble 110 and FCH 120 are shown as being ROBO mode modulated (robust OFDM mode). ROBO modulation is considered robust in the sense that it may provide four times extra redundancy parity bits by using a repetition code, and therefore the PLC network may more reliably deliver data under severe channel conditions.

FIG. 1B shows the various fields within the FCH 120. The FCH 120 in IEEE P1901.2 version 3.4 (hereafter herein “IEEE P1901.2”) has 72 bits, with 6 bits/symbol, and 12 total symbols after a bit repetition of 6. The fields in the FCH 120 include Phase Detection Counter (PDC) 121, Modulation type (MOD; such as 0 for ROBO; 1 for DBPSK and 2 for DQPSK) 122, Reserved (Rsrv) bits 123, delimiter type (DT) 124, frame length (FL; the PHY frame length in PHY symbols) 125, tone map (TM) 126 comprising TM [0:7] 126a, TM [8:15] 126b, TM [16:23] 126c, and TM [24:31] 126d, Frame Control Check Sequence (FCCS) 127, cony zeros (e.g., 6 zeros for convolutional encoder) 128, and Reserved bits 129.

FIG. 1C shows the signal processing block structure 160 for transmitting frames including the FCH 120 (transceiver not shown), including data frames and acknowledgement (ACK) frames. Signal processing block structure 160 includes information bit block 120′ provided by the FCH 120, scrambler block 161, convolutional encoder block 162, repetition rate block 163, interleaver block 164, subcarrier modulator block 165, inverse Fourier transform (IFFT) block 166, and cyclic prefix 167 block. For IEEE P1901.2 the frequency encoding rate (FEC) provided by convolutional encoder block 162 implements ½ convolutional coding with a constraint length 7. Repetition rate block 163 provides a maximum bit repetition rate of 6 (or code-rate=1/6th).

### SUMMARY

Disclosed embodiments recognize Powerline communications (PLC) channels are known to be highly challenging environments for digital communication because they suffer from periodic bursts of impulse noise, and the PLC channel impulse response also significantly varies over time. As an example, the channel response of a PLC channel as a function of time for a medium voltage to low voltage (MV-LV) powerline in the US-grid for the Federal Communications Commission (FCC)-band (150 kHz to 500 kHz) is periodically time-varying with a period of about 8 msec, or approximately ½ the AC mains cycle duration of about 16 msec. Nulls (or troughs) in the PLC channel response occur every period corresponding to times of minimum channel response. As used herein “nulls” of the PLC channel response are defined to be intervals of time when the channel response is ≦30% of the peak channel response of the PLC channel. If the physical layer (PHY) header (referred to as a frame control header (FCH) in IEEE P1901.2) occurs in one of the nulls or troughs of the PLC channel, the PHY header may not be reliably decoded which can result in the entire frame being dropped since the PHY header contains PHY frame format information needed by the receiver to synchronize to the transmitter.

As described above, the highest bit repetition rate implemented by repetition rate block 163 for IEEE P1901.2 is 6, which may result in the duration of the PHY header being on the order of, or less than, the duration of the nulls in the PLC channel response. Disclosed embodiments provide approaches for improving the reliability of PHY header decoding probability by repetition rate extending the duration of the PHY header to provide an extended duration which is at least fifty percent (50%) more than the duration or estimated duration of the nulls in the PLC channel. The repetition rate extending can be realized by employing symbol repetition or bit repetition.

### BRIEF DESCRIPTION OF THE DRAWINGS

Reference will now be made to the accompanying drawings, which are not necessarily drawn to scale, wherein:

FIGS. 1A-C show the structure based on the IEEE P1901.2 standard of a data frame for a PHY, the fields in the PHY header shown as a FCH, and the signal processing blocks for transmitting a frame including the FCH (transceiver not shown), respectively.

FIG. 2A shows the signal processing block structure for transmitting frames including a disclosed extended duration PHY header in a PLC network based on bit repetition, according to an example embodiment.

FIG. 2B shows the signal processing block structure for transmitting frames including a disclosed extended duration PHY header in a PLC network based on symbol repetition, according to an example embodiment.

FIG. 2C depicts results from an example symbol repetition process using a symbol repetition factor (x)=4, according to an example embodiment.

FIG. 2D depicts results from an example symbol repetition process for processing chunks of PHY header symbols which lack bit repetition, where a symbol repetition of 4 is used, according to an example embodiment.

FIG. 3 is a block diagram schematic of a communication device having a disclosed modem that implements extended duration PHY headers using a disclosed PHY header compiling algorithm, according to an example embodiment.

FIG. 4 is a flowchart for an example method of PLC communications using frames having extended duration PHY headers, according to an example embodiment.

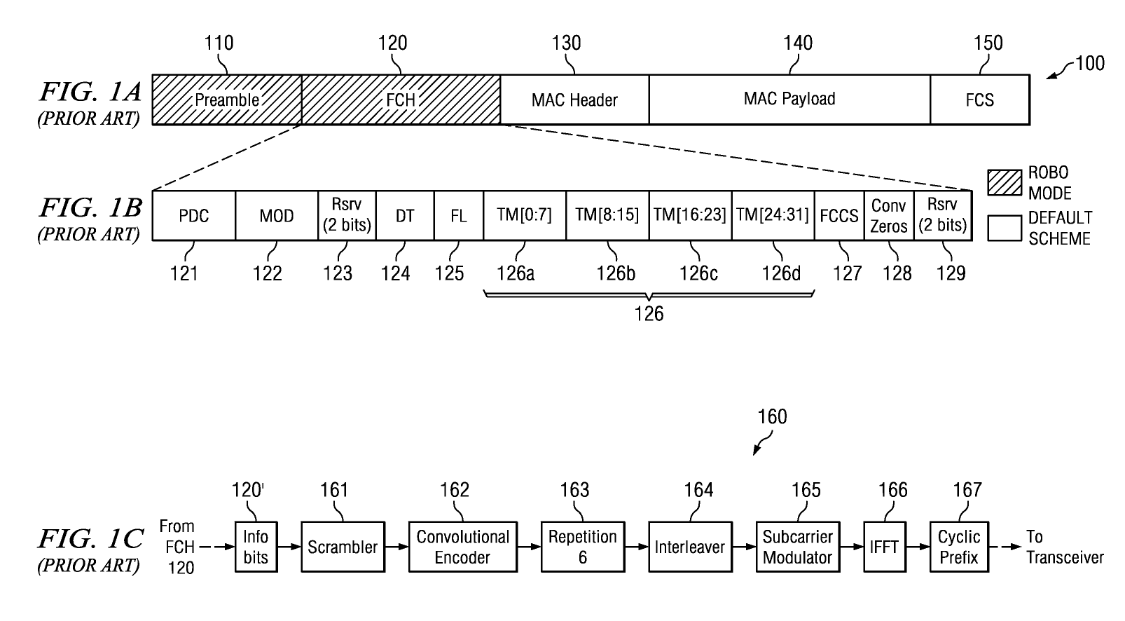

### DETAILED DESCRIPTION

Disclosed embodiments now will be described more fully hereinafter with reference to the accompanying drawings. Such embodiments may, however, be embodied in many different forms and should not be construed as limited to the embodiments set forth herein. Rather, these embodiments are provided so that this disclosure will be thorough and complete, and will fully convey the scope of this disclosure to those having ordinary skill in the art. One having ordinary skill in the art may be able to use the various disclosed embodiments and there equivalents. As used herein, the term “couple” or “couples” is intended to mean either an indirect or direct electrical connection, unless qualified as in “communicably coupled” which includes wireless connections. Thus, if a first device couples to a second device, that connection may be through a direct electrical connection, or through an indirect electrical connection via other devices and connections.

Disclosed embodiments provide repetition rate extended duration PHY headers that help avoid loss of PHY header information when the PHY header of the frame occurs in one of the nulls of the PLC channel. For example, if the bit repetition rate is too small, one or more of the PHY header symbols may coincide with channel nulls, and/or impulse noise which may substantially degrade the signal-to-noise ratio (SNR) of the PHY header. In the case of 6 repetitions in IEEE P1901.2, the FCH duration is 1.4 ms (˜231.7 μs×6 symbols). If the PLC channel null is around 1.4 ms long, one or more of the FCH symbols can be within the channel nulls, and as a result the symbols being at the nulls will not be able to be reliably decoded by the receiver. Disclosed repetition rate extended PHY headers help ensure the PHY header can operate at lower SNR, with only a small increase in PHY header overhead.

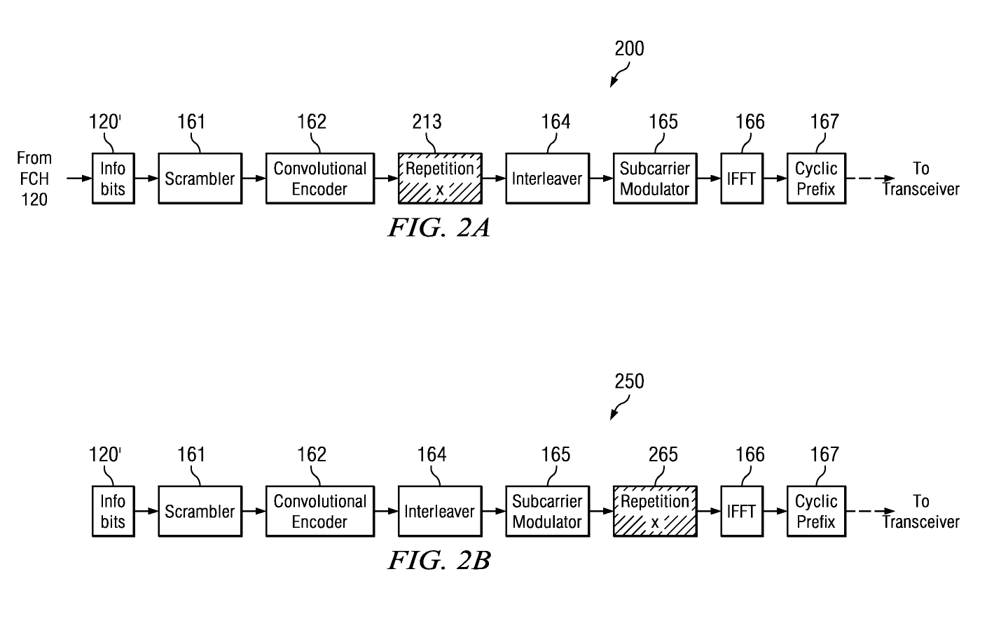

FIG. 2A shows the signal processing block structure 200 for transmitting frames including a disclosed extended PHY header in a PLC network based on bit repetition, according to an example embodiment. In this embodiment the PHY header performance can be enhanced by a bit repetition code block 213 having a sufficiently high bit repetition rate to extend the duration of the PHY header relative to the channel nulls at the output of the convolutional encoder bock 162. In one example embodiment, convolutional encoder block 162 implements ½ convolutional coding with bit repetition code block 213 providing a bit repetition rate of ≧8 (or code-rate≦=1/8th). A rate x repetition code repeating bits by x times provides a 10 log₁₀(x/6) dB SNR improvement on an Additive White Gaussian Noise (AWGN) PLC channel, and possibly a higher enhancement for different channel profiles. One advantage of signal processing block structure 200 is that it is simple to implement, such as through minimal changes to the IEEE P1901.2 standard PHY transmitter.

The repetition rate x implemented by bit repetition code block 213 can be, for example, 8, 12 or 16 to provide a code rate of 1/8^{th}, 1/12^{th}, or 1/16^{th}. In IEEE P1901.2, the symbol length is approximately 200 μs. Using a disclosed repetition rate of 16, the symbol length is increased by 3.2 ms, which can help cope with the PLC channel response variation with time which includes nulls as described above.

FIG. 2B shows the signal processing block structure 250 for transmitting frames including a disclosed extended PHY header in a PLC network based on symbol repetition, according to an example embodiment. In this embodiment, a symbol repetition block 265 after the subcarrier modulation block 165 repeats the modulated symbols instead of repeating bits, i.e., the repetition is performed at the symbol level, not at the bit level. Symbol repetition may offer more time diversity as compared to bit level repetition because if one symbol is erased (not recoverable) due to difficult PLC channels in time (e.g., channel nulls and/or impulse noise), the other same (repeated) symbols can recover the otherwise lost information. The symbol repetition rate can increase the number of PHY header symbols by at least 33% from a PLC standard, such as from 12 symbols in IEEE P1901.2, up to 16 symbols, or more.

In IEEE P1901.2, without the bit repetition rate of 6, the total number of symbols require 72 bits*2/(72 tones/symbols)=2 symbols (2*6=12). In this case, there are total 72 tones per one OFDM symbol, where Si(j) means a modulated sample at the j-th tone at the i-th symbol, where Si(1) is the pilot for the i-th symbol. With a symbol repetition rate of 4 provided by symbol repetition block 265 of signal processing block structure 250, one can repeat the symbols four times consecutively. In case the symbols in a disclosed PHY frame are subjected to high impulse noise or a channel null, the repetition at the symbol level offers more time diversity, since if the PHY header is subjected to channel variation or impulse noise and some of the symbols are affected, the information can be recovered by the other unaffected repeated symbols provided by the symbol repetition process.

FIG. 2C depicts results from an example symbol repetition process using a symbol repetition factor (x)=4, according to an example embodiment. The symbols are shown as S1 and S2 at tones 1 through 72, which can be seen to be repeated 4 times to extend the duration of the PHY header.

For the case of “coherent” combining, the respective samples Si(j) are combined at the output of the IFFT 166. This embodiment recognizes coherently combining symbols allows the reliability of received samples to be increased and the combined symbols can then be differentially demodulated at the receiver. The symbol repetition factor x is ≧2, such as 2, 4, 6, 8, 16, etc.

Another embodiment applies when there are symbols in the PHY header without bit repetition, for example 2 symbols available without bit repetition. In this embodiment, chunks of such symbols without bit repetition are repeated, such as by repeating symbol1, symbol2 to result in symbol1, symbol2, symbol1, symbol2, . . . An example of this embodiment is shown in FIG. 2D, where a symbol repetition factor of 4 is used. Instead, the symbol repetition factor can be 2, 6, 8, 16, etc.

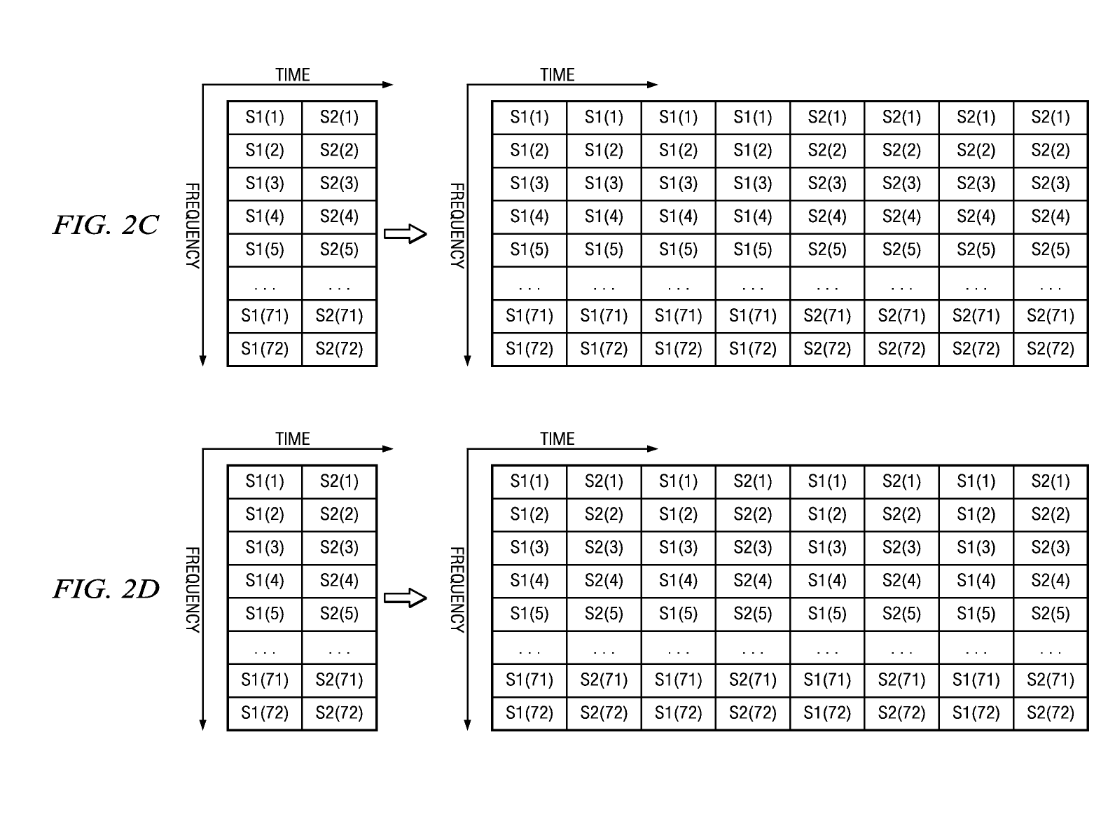

FIG. 3 is a block diagram schematic of a communication device 300 having a disclosed modem 304 that implements extended duration PHY headers using a disclosed PHY header compiling algorithm, according to an example embodiment. Communications device 300 can be used at a service node (which includes switch nodes and terminal nodes) or a base (data concentrator) node in the PLC communications network.

Modem 304 includes a processor (e.g., a digital signal processor, (DSP)) 304a coupled to an associated memory 305 that that stores a disclosed PHY header compiling algorithm which provides code for the PHY header compiling algorithm. Modem 304 can implement all the blocks shown in FIGS. 2A-D.

Memory 305 comprises non-transitory machine readable storage, for example, static random-access memory (SRAM). In operation, the processor 304a is programmed to implement the PHY header compiling algorithm. Modem 304 includes a timer 307, such as for ACK transmission, Carrier Sense Multiple Access/collision avoidance (CSMA)/CA) back-off and data transmission purposes.

The PLC transceiver (TX/RX) 306 is communicably coupled to the modem 304 for coupling of the communications device 300 to the shared powerline 340. Transceiver 306 facilitates communications with other SNs and the BN on the powerline 340.

The modem 304 is shown formed on an integrated circuit (IC) 320 comprising a substrate 325 having a semiconductor surface 326, such as a silicon surface. Memory 305 may be included on the IC 320. In another embodiment the modem 304 is implemented using 2 processor chips, such as 2 DSP chips. Besides the DSP noted above, the processor 304a can comprise a desktop computer, laptop computer, cellular phone, smart phone, or an application specific integrated circuit (ASIC).

Disclosed modems 304 and disclosed communications devices 300 can be used in a PLC network to provide a networked device that in service is connected to a powerline via a power cord. In general, the “networked device” can be any equipment that is capable of transmitting and/or receiving information over a powerline. Examples of different types of networked devices include, but are not limited or restricted to a computer, a router, an access point (AP), a wireless meter, a networked appliance, an adapter, or any device supporting connectivity to a wired or wireless network.

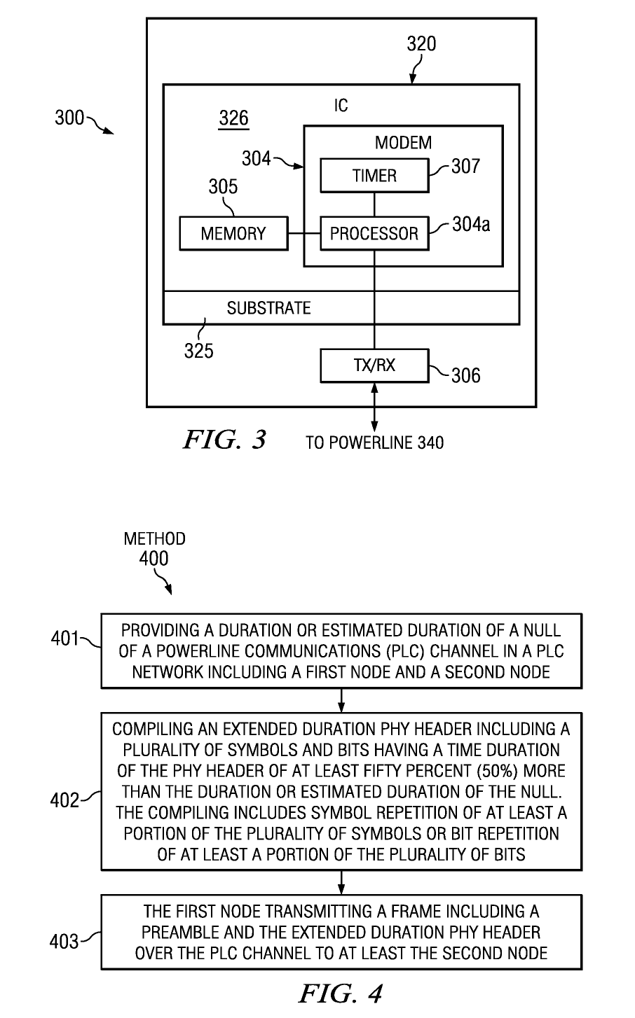

FIG. 4 is a flowchart for an example method of powerline communications over a PLC channel including a first node and at least a second node, using a disclosed algorithm that compiles frames (data, ACK or NACK) having extended duration PHY headers, according to an example embodiment. Step 401 comprises providing a duration of a null of the PLC channel or an estimated duration of the null. Due to the periodicity of the channel response of the PLC channel and relationship to the AC mains cycle duration (e.g., typically ½ the AC mains cycle duration), the channel response can generally be reliably estimated. Step 402 comprises compiling an extended duration PHY header including a plurality of symbols and bits at the first node having a time duration of the PHY header of at least fifty percent (50%) more than the duration or estimated duration of the null. The compiling includes symbol repetition of at least a portion of the plurality of symbols or bit repetition of at least a portion of the plurality of bits. Step 403 comprises the first node transmitting a frame including a preamble and the extended duration PHY header over the PLC channel to at least the second node.

When the compiling comprises bit repetition, the repetition rate for bit repetition can be 8, 12 or 16. When the compiling comprises symbol repetition, the symbol repetition rate can increase the number of PHY header symbols by at least 33% from a PLC standard, such as from 12 symbols in IEEE P1901.2 to up to 16 symbols, or more. The second node (receiving node) can utilize differential demodulation of the frame having the extended duration PHY header.

The method can further comprise dynamic switching of PHY headers using a sensed channel condition on the PLC channel to determine when to switch between using a disclosed extended duration PHY header and using a lower duration PHY header, such as a conventional FCH in IEEE P1901.2. In this embodiment the second node can obtain the sensed channel condition from decoding the preamble of the frame, and the second node can then transmit the sensed channel condition to the first node. For example, the channel variation can be sensed at the preamble detection stage (the symbols before the PHY header) at the receiver, and the receiver can then feedback the channel condition information derived from preamble detection to the transmitter. The transmitter can then adaptively select the repetition rate. This embodiment allows use of frames having disclosed extended duration PHY headers during the presence of difficult PLC channel conditions, and the use of conventional duration PHY header otherwise to eliminate the small increase in PHY header overhead when using disclosed extended duration PHY headers.

Many modifications and other embodiments of the invention will come to mind to one skilled in the art to which this Disclosure pertains having the benefit of the teachings presented in the foregoing descriptions, and the associated drawings. Therefore, it is to be understood that embodiments of the invention are not to be limited to the specific embodiments disclosed. Although specific terms are employed herein, they are used in a generic and descriptive sense only and not for purposes of limitation.

We claim:

1. A method of powerline communications in a powerline communications (PLC) network over a PLC channel including a first node and at least a second node, comprising:
providing a duration of a null of said PLC channel or an estimated duration of said null;
compiling an extended duration physical layer (PHY) header including a plurality of symbols and bits having a time duration of said PHY header of at least fifty percent (50%) more than said duration or said estimated duration of said null, wherein said compiling includes symbol repetition of at least a portion of said plurality of symbols or bit repetition of at least a portion of said plurality of bits, and
said first node transmitting a frame including a preamble and said extended duration PHY header over said PLC channel to at least said second node.

2. The method of claim 1, wherein said compiling comprises said bit repetition, and wherein a repetition rate for said bit repetition is 8, 12 or 16.

3. The method of claim 1, wherein said compiling comprises said symbol repetition.

4. The method of claim 3, wherein said second node utilizes differential demodulation of said frame.

5. The method of claim 1, further comprising using a sensed channel condition on said PLC channel to switch between said compiling of said extended duration PHY header and a compiling of a lower duration PHY header.

6. The method of claim 5, wherein said second node obtains said sensed channel condition from decoding said preamble, and said second node transmits said sensed channel condition to said first node.

7. The method of claim 1, wherein said compiling comprises said symbol repetition by repeating in chunks at least one of said plurality of symbols which lacks said bit repetition.

8. A modem for communications on a powerline communications (PLC) channel in a PLC network including a first node and at least a second node, comprising:
a processor;
wherein said processor is coupled to a memory which stores a frame compiling algorithm including code for compiling extended duration PHY headers, and wherein said processor is programmed to implement said frame compiling algorithm, said frame compiling algorithm:
compiling a frame comprising a preamble, an extended duration PHY header, a MAC header and a MAC payload, wherein said extended duration PHY header includes a plurality of symbols and bits having a time duration of at least fifty percent (50%) more than a duration or an estimated duration of a null in said PLC channel, and wherein said compiling includes symbol repetition of at least a portion of said plurality of symbols or bit repetition of at least a portion of said plurality of bits, and
wherein said modem is configured for coupling to a PLC transceiver to provide said frame to said PLC transceiver so that said PLC transceiver transmits said frame from said first node over said PLC channel to at least said second node.

9. The modem of claim 8, wherein said modem is formed on an integrated circuit (IC) comprising a substrate having a semiconductor surface, wherein said processor comprises a digital signal processor (DSP).

10. The modem of claim 8, wherein said compiling comprises said symbol repetition.

11. The modem of claim 8, wherein said compiling comprises said bit repetition, and wherein a repetition rate for said bit repetition is 8, 12 or 16.

12. The modem of claim 8, wherein said modem uses a sensed channel condition on said PLC channel to switch between said compiling of said extended duration PHY header and a compiling of a lower duration PHY header.

13. A communications device for communications on a powerline communications (PLC) channel in a PLC network including a first node and at least a second node, comprising:
a memory which stores a frame compiling algorithm including code for compiling extended duration PHY headers,
a modem coupled to said memory, said modem comprising:
a processor coupled to said memory, wherein said processor is programmed to implement said frame compiling algorithm, said frame compiling algorithm:
compiling a frame comprising a preamble, an extended duration PHY header, a MAC header and a MAC payload, wherein said extended duration PHY header includes a plurality of symbols and bits having a time duration of at least fifty percent (50%) more than a duration or an estimated duration of a null in said PLC channel, and wherein said compiling includes symbol repetition of at least a portion of said plurality of symbols or bit repetition of at least a portion of said plurality of bits, and
a PLC transceiver communicably coupled to said modem for transmitting frames including said frame from said first node to at least said second node.

14. The communications device of claim 13, wherein said modem is formed on an integrated circuit (IC) comprising a substrate having a semiconductor surface, wherein said processor comprises a digital signal processor (DSP).

15. The communications device of claim 13, wherein said compiling comprises said bit repetition, and wherein a repetition rate for said bit repetition is 8, 12 or 16.

16. The communications device of claim 13, wherein said compiling comprises said symbol repetition.

17. The communications device of claim 16, wherein said second node utilizes differential demodulation of said frame.

18. The communications device of claim 13, wherein said frame compiling algorithm uses a sensed channel condition on said PLC channel to switch between said compiling of said extended duration PHY header and a compiling of a lower duration PHY header.

19. The communications device of claim 18, wherein said second node obtains said sensed channel condition from decoding said preamble, and said second node transmits said sensed channel condition to said first node.
